(19) United States
(12) Patent Application Publication
(10) Pub. No.: US 2024/0323851 A1
(43) Pub. Date: Sep. 26, 2024

(54) COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN)

(21) Appl. No.: 18/733,274

(22) Filed: Jun. 4, 2024

Related U.S. Application Data
(63) Continuation of application No. PCT/CN2021/136777, filed on Dec. 9, 2021.

(51) Int. Cl. H04W 52/02

(52) U.S. Cl. CPC H04W 52/0235

(57) ABSTRACT

A communication method, a terminal device, and a network device are provided. The communication method includes the following. The terminal device receives first configuration information sent by a network device, where the first configuration information is used for determining a reception state of the terminal device, and the reception state includes a low-power wake-up signal (LP-WUS) reception state or a normal reception state. In the normal reception state, the terminal device can have relatively high receiving sensitivity; while in the LP-WUS reception state, the terminal device can have relatively low power consumption.

### CROSS-REFERENCE TO RELATED APPLICATION(S)

This application is a continuation of International Application No. PCT/CN2021/136777, filed Dec. 9, 2021, the entire disclosure of which is incorporated herein by reference.

### TECHNICAL FIELD

The disclosure relates to the field of communication technology, and more particularly, to a communication method, a terminal device, and a network device.

### BACKGROUND

With an (ultra-)low power wake-up signal (LP-WUS), it is possible to reduce unnecessary paging monitoring of a terminal device, thereby realizing power saving of the terminal device. However, an LP-WUS receiver is poor in sensitivity, and accordingly, a coverage range supported by the LP-WUS is degraded.

### SUMMARY

In a first aspect, a communication method is provided. The communication method includes the following. A terminal device receives first configuration information sent by a network device, where the first configuration information is used for determining a reception state of the terminal device, and the reception state includes an LP-WUS reception state or a normal reception state.

In a second aspect, a network device is provided. The network device includes a transceiver, a processor, and a memory storing computer readable programs. The processor is configured to invoke and execute the computer readable programs to: cause the transceiver to send first configuration information to a terminal device, where the first configuration information is used for determining a reception state of the terminal device, and the reception state includes an LP-WUS reception state or a normal reception state.

In a third aspect, a terminal device is provided. The terminal device includes a transceiver, a processor, and a memory storing computer readable programs. The processor is configured to invoke and execute the computer readable programs to: cause the transceiver to to receive first configuration information sent by a network device, where the first configuration information is used for determining a reception state of the terminal device, and the reception state includes an LP-WUS reception state or a normal reception state.

### BRIEF DESCRIPTION OF THE DRAWINGS

FIG. 1 illustrates a wireless communication system to which embodiments of the disclosure are applied.

FIG. 2 is a schematic diagram illustrating working principles of a low power wake-up signal (LP-WUS) receiver.

FIG. 3 is a schematic flowchart of a communication method provided in embodiments of the disclosure.

FIG. 4 is a schematic flowchart of another communication method provided in embodiments of the disclosure.

FIG. 5 is a schematic flowchart of another communication method provided in embodiments of the disclosure.

FIG. 6 is a schematic structural diagram of a terminal device provided in embodiments of the disclosure.

FIG. 7 is a schematic structural diagram of a network device provided in embodiments of the disclosure.

FIG. 8 is a schematic structural diagram of an apparatus provided in embodiments of the disclosure.

### DETAILED DESCRIPTION

The following will describe technical solutions of the disclosure with reference to the accompanying drawings.

### Communication System

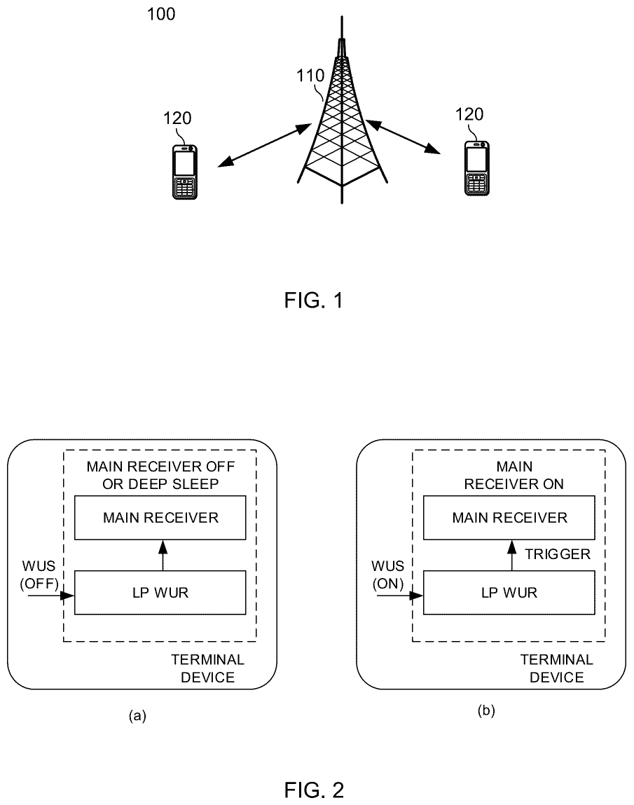

FIG. 1 illustrates a wireless communication system 100 to which embodiments of the disclosure are applied. The wireless communication system 100 may include a network device 110 and a terminal device 120. The network device 110 may be a device for communicating with the terminal device 120. The network device 110 may provide communication coverage for a particular geographic region, and may communicate with the terminal device(s) 120 located within the coverage region.

FIG. 1 exemplarily illustrates one network device and two terminals. Optionally, the wireless communication system 100 may include multiple network devices, and there may be other quantities of terminal devices in a coverage area of each of the multiple network devices, and embodiments of the disclosure are not limited in this regard.

Optionally, the wireless communication system 100 may further include other network entities such as a network controller and a mobility management entity, which is not limited in embodiments of the disclosure.

It should be understood that, technical solutions in embodiments of the disclosure may be applied to various communication systems, such as a 5th generation (5G) system or new radio (NR), a long term evolution (LTE) system, an LTE frequency division duplex (FDD) system, and an LTE time division duplex (TDD) system. The technical solutions provided in the disclosure may also be applied to a future communication system, such as a 6th generation (6G) mobile communication system and a satellite communication system.

The 5G system studied by the 3rd generation partnership project (3GPP) aims to meet people's requirements on rate, delay, high-speed mobility, and energy efficiency, and is adapted to diversity and complexity of services in future life. The 5G system is mainly applied to enhanced mobile broadband (eMBB), ultra-reliable low-latency communication (URLLC), and massive machine type communication (mMTC).

eMBB still aims to enable users to obtain multimedia content, services, and data, and grows rapidly in demands. On the other hand, because eMBB may be deployed in different scenarios, such as indoor, urban, rural, etc., its capabilities and requirements vary widely, and it is necessary to analyze in combination with specific deployment scenarios. URLLC is typically applied to industrial automation, power automation, telemedicine operations, and traffic safety assurance, etc. mMTC is typically characterized by high connection density, small amount of data, delay-insensitive services, low cost of modules, and long service life, etc.

The terminal device in embodiments of the disclosure may also be referred to as a user equipment (UE), an access terminal, a subscriber unit, a subscriber station, a mobile station (MS), a mobile terminal (MT), a remote station, a remote terminal, a mobile device, a user terminal, a terminal, a wireless communication device, a user agent, or a user apparatus. The terminal device in embodiments of the disclosure may refer to a device providing voice and/or data connectivity for a user, and may be used for connecting a person, an object, and a machine, for example, various devices having wireless connection functions such as a handheld device, an in-vehicle device, and the like. The terminal device in embodiments of the disclosure may be a mobile phone, a pad, a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, and the like. Optionally, the UE may be used as a base station. For example, the UE may act as a scheduling entity providing sidelink signals between UEs in vehicle to everything (V2X) or device to device (D2D), etc., for example, a cellular radio telephone and an automobile communicate with each other via side-link signals, while a cellular radio telephone and a smart home device can communicate with each other without relaying communication signals via a base station.

The network device in embodiments of the disclosure may be a device for communicating with the terminal device. The network device may also be referred to as an access network device or a radio access network (RAN) device, for example, the network device may be a base station. The network device in embodiments of the disclosure may refer to a RAN node (or device) that enables the terminal device to access a radio network. The base station in a broad sense may cover various names or replace the following names, for example, a NodeB or an evolved NodeB (eNB), a next generation node B (gNB), a relay node, an access point (AP), a transmission and reception point (TRP), a transmission point (TP), a master station (MeNB), a secondary station (SeNB), a multi-mode radio (MSR) node, a home base station, a network controller, an access node, a radio node, and an AP, a transmission node, a transmission and reception node, a baseband unit (BBU), a remote radio unit (RRU), an active antenna unit (AAU), a remote radio head (RRH), a central unit (CU), a distributed unit (DU), a positioning node, and the like. The base station may be a macro base station, a micro base station, a relay node, a donor node, or the like, or a combination thereof. The base station may also refer to a communication module, a modem, or a chip that is configured in the foregoing device or apparatus. The base station may also be a mobile switching center, a device acting as a base station in device-to-device D2D communication, V2X communication, or machine-to-machine (M2M) communication, a network-side device in a 6G network, a device acting as a base station in a future communication system, etc. The base station may support networks of the same or different access technologies, and there is no limitation on the technology and device form adopted by the network device in embodiments of the disclosure.

The base station may be fixed or mobile. For example, a helicopter or unmanned aerial vehicle (UAV) may be configured to act as a mobile base station, and one or more cells may move according to a position of the mobile base station. In other examples, the helicopter or UAV may be configured to act as a device for communicating with another base station.

In some deployments, the network device in embodiments of the disclosure may refer to a CU or a DU, or the network device includes a CU and a DU. The gNB may also include an AAU.

The network device and the terminal device may be deployed on land, including indoor or outdoor, handheld, or in-vehicle; or may be deployed on water; or may be deployed on aircraft, balloons, and satellites in the air, and embodiments of the disclosure do not limit the scenario that the network device and the terminal device are in.

It should be understood that, all or some of functions of the communication device in the disclosure may also be implemented by a software function run on hardware, or may be implemented by a virtualization function instantiated on a platform (for example, a cloud platform).

### Radio Resource Control (RRC) State

In a communication system such as an NR system, an RRC state may include an RRC idle state (RRC_IDLE), an RRC connected state (RRC_CONNECTED), an RRC inactive state (RRC_INACTIVE), and the like.

In RRC_IDLE, a terminal device and a network device do not have RRC connection. Mobility of the terminal device is mainly based on cell re-selection of the terminal device. In RRC_IDLE, paging of the network device to the terminal device is initiated by a core network (CN), and a paging area is configured by the CN. In addition, in RRC_IDLE, the network device does not have terminal-device access stratum (AS) context.

In RRC_CONNECTED, there is an RRC connection between the terminal device and the network device. Both the network device and the terminal device have terminal-device AS context. In RRC_CONNECTED, the network device knows that a location of the terminal device is cell level-based. In RRC_CONNECTED, unicast data can be transmitted between the terminal device and the network device, and mobility of the terminal device is managed and controlled by the network device.

In the RRC_INACTIVE state, air-interface signaling of the communication system can be reduced. The terminal device in the RRC_INACTIVE state can recover radio connection quickly, and can also recover data service quickly. In RRC_INACTIVE, there is a CN-NR connection. Terminal-device AS context is stored in some network device. In addition, in RRC_INACTIVE, paging of the network device to the terminal device is triggered by a RAN, a RAN-based paging area may be managed by the RAN. Furthermore, in RRC_INACTIVE, the network device knows that the location of the terminal device is RAN-based paging area level.

### Paging Mechanism

A paging functionality may include: when a terminal device is in an RRC_IDLE or an RRC_INACTIVE state, a network device may page the terminal device by using a paging message. The paging functionality may further include: when the terminal device is in any RRC state (including an RRC_CONNECTED state, an RRC_IDLE state, or an RRC_INACTIVE state), the network device notifies to the terminal device system message change or earthquake and tsunami warning information/public warning information by using a short message.

Paging may be implemented by using a physical downlink control channel (PDCCH) scrambled by a paging radio network temporary identity (P-RNTI), or may be implemented by using a physical downlink shared channel (PDSCH) scheduling the PDCCH. For example, the paging message may be transmitted on the PDSCH, or the short message may be transmitted on the PDCCH, where the short message may occupy 8 bits in the PDCCH.

When the terminal device is in an RRC_IDLE state or an RRC_INACTIVE state, the terminal device and the network device may have no data communication other than paging. In order to reduce power consumption of the terminal device, the terminal device may monitor a paging channel discontinuously, that is, the terminal device may use a paging discontinuous reception (paging DRX) mechanism. In the paging DRX mechanism, the terminal device only needs to monitor the paging channel during a paging occasion (PO) in each DRX cycle. Taking the specification in technical specification (TS) 38.304 as an example, the PO may include multiple PDCCH monitoring occasions in a paging search space. Each PO may include X PDCCH monitoring occasions, where X is equal to the number of actually transmitted synchronization signal blocks (SSB) that is broadcast in a master information block (MIB). Multiple POs or a starting point of each of the multiple POs may be contained in a paging frame (PF). The PF may be a radio frame, and the length of the radio frame may be fixed to 10 milliseconds (ms).

A paging DRX cycle may be determined according to a common cycle broadcast in system information as well as a specific cycle configured via higher-layer signaling (such as non-access stratum (NAS) signaling). The terminal device may take the minimum between the common cycle and the specific cycle as the paging DRX cycle. For example, if a terminal device-specific paging DRX cycle is configured for the terminal device by an RRC/upper layer, the minimum between a paging DRX cycle broadcast by the network device and the terminal device-specific paging DRX cycle configured by the RRC/upper layer will be taken as the paging DRX cycle of the terminal device. Alternatively, if the terminal device-specific paging DRX cycle is not configured for the terminal device by the RRC/upper layer, the paging DRX cycle broadcast by the network device will be taken as the paging DRX cycle of the terminal device.

From the perspective of the network device, each paging DRX cycle may include multiple POs, and a point at which the terminal device monitors a PO may depend on an identity (ID) of the terminal device. A scheme for PF and PO determination by the terminal device in a paging DRX cycle will be described below by taking the specification in TS 38.304 as an example.

A system frame number (SFN) for a PF may be determined according to the following formula:

$$( SFN + PF \_offset ) mod T = ( T div N ) * ( UE \_ ID mod N )$$

An index i_s of a PO in a PF may be determined according to the following formula:

i_s=floor(UE_ID/N)mod Ns

In the above two formulae, T may represent a DRX cycle for the terminal device to receive paging. T may be, for example, the minimum between the common cycle broadcast and the specific cycle configured via higher-layer signaling. N may represent the number of PFs in each T. PF_offset may be used for determining a time-domain offset for a PF. UE_ID may be calculated according to the ID of the terminal device, for example, may be calculated according to a 5G system architecture evolution temporary mobile subscriber identity (5G-S-TMSI). Optionally, UE_ID may be 5G-S-TMSI mod 1024. Ns may represent the number of POs for a PF. mod represents a modulo operation. floor represents a floor operation.

The terminal device may calculate a PF, an index of a PO in a PF, and the number of PDCCH monitoring occasions in a PO according to the above two formulae. As such, the terminal device can obtain a starting point of a 1st PDCCH monitoring occasion for the PO according to related configuration parameters, so as to determine the PO. Then, the terminal device can perform blind detection of a paging message according to the determined PO.

### Paging False Alarm

As can be seen from the foregoing scheme for PO determination by the terminal device, PO determination is related to the ID of the terminal device, the total number of PFs, and the total number of POs. If there are a large number of terminal devices in a communication system, it will be difficult for the network device to allocate a different PO to each terminal device, and therefore, multiple terminal devices may correspond to one PO. If the network device needs to page a certain terminal device corresponding to the PO, other terminal devices corresponding to the PO are likely to perform blind detection. That is, some terminal devices that have no paging message perform unnecessary blind detection, and such unnecessary blind detection may be referred to as a paging false alarm.

With regard to the foregoing problem, in the related art, an enhanced paging mechanism is designed to reduce unnecessary paging reception of the terminal device, thereby reducing paging false alarms.

Taking studies and discussion of 3GPP radio access network (RAN) as an example, in the work item of release 17 (R17), 3GPP RAN group has agreed to further enhance power saving of the terminal device (RP-193239), and has agreed to introduce a paging early indication (PEI) mechanism and a terminal device subgrouping mechanism to reduce paging false alarms.

The PEI mechanism may be implemented by using a PDCCH or a sequence, where the sequence may be, for example, a signal like a secondary synchronization signal (SSS) or a tracking reference signal (TRS). In an implementation, the network device may send a PEI before a PO, and the terminal device may determine, according to an indication of the PEI received, whether to perform paging monitoring at a corresponding PO or to skip paging monitoring. It can be understood that, the PEI may be a wake up signal (WUS).

In a terminal device subgrouping-based paging mechanism, the network device may divide multiple terminal devices corresponding to the same PO into subgroups. The network device may indicate which terminal device or which terminal device subgroup a paging message is intended for. The terminal device or terminal device subgroup indicated may receive the paging message, and terminal devices in other subgroups do not have to receive the paging message. Optionally, paging subgrouping indication information may be carried in the PEI.

### (Untra-)Low Power WUS (LP-WUS)

An LP-WUS is a new signal. Power consumption of an LP-WUS receiver is far lower than power consumption of a main receiver (main radio). Therefore, the LP-WUS is advantageous over the PEI in power saving.

It should be noted that, in some embodiments, the LP-WUS receiver may also be referred to as an LP wake-up receiver (LP WUR) or an almost zero power WUR (AZP WUR).

When the terminal device is in a normal reception state, the main receiver monitors a paging message, and power consumption of the main receiver is relatively high. When the terminal device is in an LP-WUS reception state, the main receiver may be turned off and the LP-WUS receiver is turned on. When the main receiver is off, the terminal device may use the LP-WUS receiver to receive a signal. Since power consumption of the LP-WUS receiver is very low, it is possible to realize power saving.

FIG. 2 is a schematic diagram illustrating working principles of the LP-WUS receiver. As illustrated in FIG. 2(a), when the WUS indicates “off”, the terminal device may use the LP-WUS receiver, and the main receiver of the terminal device is in an off state or deep sleep state, that is, the terminal device does not use the main receiver. As illustrated in FIG. 2(b), when the WUS indicates “on”, the terminal device may trigger turning-on of the main receiver, so that the terminal device may use the main receiver to receive a message (for example, monitor a paging message). It should be noted that, there is no limitation on the implementation of the LP-WUS in the disclosure, for example, the LP-WUS may be implemented based on on-off keying (OOK) or in other forms.

Table 1 shows a comparison between R15 IDLE, an R17 PEI, and the LP-WUS receiver in terms of performance. As can be seen from Table 1, although power consumption of the terminal device can be reduced with aid of the LP-WUS receiver, sensitivity of the LP-WUS receiver is degraded, and accordingly, coverage range supported by the LP-WUS is degraded. In addition, if the LP-WUS does not have measurement functionality or is poor in measurement functionality, mobility of the terminal device is likely to be affected in case the main receiver is turned off.

TABLE 1

| | Coverage | | | | |
|---|---|---|---|---|---|
| Solution | range | Sensitivity | Power consumption | | Signals |
| Rel-15 IDLE | >500 m | ~−100 dBm | 1X | | No WUS |
| R17 PEI for | >500 m | ~−100 dBm | 30~50 mW | 0.8~0.9 X | PEI, which may be |
| IDLE | | | | | either PDCCH based, |
| | | | | | or sequence based |
| LP-WUS | 100 m~200 m | −70-−90 dBm | <100 uW | 0.001~0.01 X | New signal, which |
| receiver | | | | | may be, for example, |
| | | | | | implemented based |
| | | | | | on OOK waveform |

The disclosure provides a communication method, a network device, and a terminal device, so as to solve the problem of poor sensitivity of a low-power wake-up signal (LP-WUS) receiver.

The disclosure provides a communication method, so as to solve the problem regarding receiving sensitivity degradation of the terminal device after the terminal device enters an LP-WUS state, which takes both high sensitivity and low power consumption into consideration.

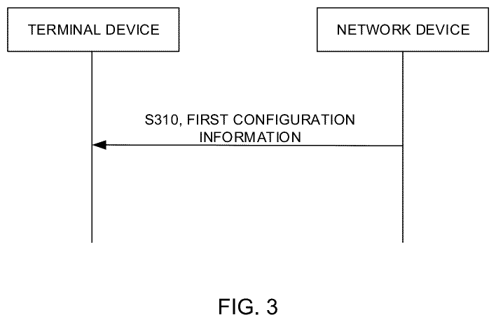

FIG. 3 is a schematic flowchart of a communication method provided in embodiments of the disclosure. The method illustrated in FIG. 3 may be performed by the terminal device and the network device described above. The method illustrated in FIG. 3 may include step S310.

Step S310, a terminal device receives first configuration information sent by a network device.

The first configuration information may be used for determining a reception state of the terminal device, where the reception state may include an LP-WUS reception state or a normal reception state.

In the normal reception state, the terminal device may turn off an LP-WUS receiver, and turn on a main receiver to receive a message. In the LP-WUS reception state, the terminal device may turn off the main receiver or make the main receiver enter a deep sleep state, and turn on the LP-WUS receiver to receive a signal.

In the normal reception state, the terminal device can have relatively high receiving sensitivity; while in the LP-WUS reception state, the terminal device can have relatively low power consumption. According to the disclosure, the network device or the terminal device may determine the reception state of the terminal device according to the first configuration information, so that the terminal device transitions the reception state in different cases, which takes both high sensitivity and low power consumption of the terminal device into consideration.

It should be noted that, there is no limitation on the manner for transmitting the first configuration information in the disclosure, for example, the first configuration information may be transmitted via a system message, RRC signaling, or media access control-control element (MAC CE) signaling.

As an implementation, the terminal device may determine a first condition and a second condition according to the first configuration information. The first condition and the second condition may be related to a channel quality of a serving cell for the terminal device. The first condition may be used for determining the LP-WUS reception state, and the second condition may be used for determining the normal reception state.

In the case of high channel quality, the terminal device may enter the LP-WUS reception state, thereby reducing power consumption and realizing power saving. In the case of poor channel quality, the terminal device may enter the normal reception state, thereby achieving high receiving sensitivity. Therefore, by determining the reception state of the terminal device according to the channel quality, both high sensitivity and low power consumption can be taken into consideration properly.

As another implementation, the terminal device may determine a low mobility criterion based on the first configuration information. The low mobility criterion may be used for determining mobility of the terminal device. If the terminal device is in low mobility or stationary, it can be determined that the terminal device fulfills the low mobility criterion. In some implementations, the low mobility criterion may also be a stationary criterion.

There is no limitation on the manner for determination regarding the low mobility criterion in the disclosure. For example, the first configuration information may include a channel quality change threshold and an evaluation duration. The low mobility criterion may include: within the evaluation duration, a change amount of a signal quality measurement result of the serving cell for the terminal device is less than or equal to the channel quality change threshold.

It can be understood that, by determining the state of the terminal device based on the low mobility criterion, it is possible to determine the reception state of the terminal device based on the mobility of the terminal device. If the terminal device becomes weak in measurement functionality after entering the LP-WUS reception state, the terminal device enters the LP-WUS reception state when the terminal device is in low mobility, and as such, impact of poor measurement functionality on mobility management of the terminal device can be reduced as much as possible. When the terminal device is in high mobility, the terminal device may enter the normal reception state, so that the terminal device is strong in measurement functionality, thereby satisfying requirements of mobility management of the terminal device.

Optionally, the reception state of the terminal device may be determined according to the first condition, the second condition, and the low mobility criterion. For example, the LP-WUS reception state may be determined according to the first condition as well as the low mobility criterion, or the normal reception state may be determined according to the second condition as well as the low mobility criterion.

By determining the reception state of the terminal device according to the low mobility criterion as well as a condition (for example, the first condition or the second condition) related to a channel quality of a cell, it is possible to take into consideration the mobility of the terminal device in addition to the channel quality of the cell, which is conducive to distinguishing different scenarios more accurately, thereby determining the reception state of the terminal device more properly.

It can be understood that, the reception state may be determined autonomously by the terminal device, or may be determined by the network device, and the disclosure is not limited in this regard. The following will describe in detail a method for determining the reception state by the terminal device or by the network device with reference to different determination conditions.

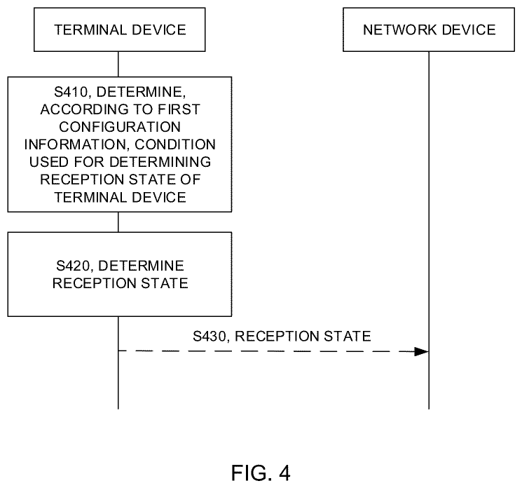

FIG. 4 is a schematic flowchart of a method for determining the reception state autonomously by the terminal device provided in embodiments of the disclosure. The method illustrated in FIG. 4 may be performed by the terminal device and the network device. The method illustrated in FIG. 4 may include step S410 and step S420.

Step S410, the terminal device determines, according to the first configuration information, a condition(s) used for determining the reception state of the terminal device.

Exemplarily, the condition used for determining the reception state of the terminal device includes at least one of the first condition, the second condition, or the low mobility criterion. Step S410 may include step S411 or step S412. Step S411, the terminal device may determine the first condition and the second condition according to the first configuration information. S412, the terminal device may determine the first condition, the second condition, and the low mobility criterion according to the first configuration information.

Step S420, the terminal device determines the reception state of the terminal device according to a channel quality measurement result of the serving cell for the terminal device.

Based on step S411, step S420 may include step S421 and step S422. Step S421, if the channel quality measurement result of the serving cell for the terminal device satisfies the first condition, the terminal device may autonomously determine the reception state to be the LP-WUS reception state. Step S422, if the channel quality measurement result of the serving cell for the terminal device satisfies the second condition, the terminal device may autonomously determine the reception state to be the normal reception state.

Based on step S412, step S420 may include step S423 and step S424. Step S423, if the channel quality measurement result of the serving cell for the terminal device satisfies the first condition and the terminal device fulfills the low mobility criterion, the terminal device may determine the reception state to be the LP-WUS reception state. Step S424, if the channel quality measurement result of the serving cell for the terminal device satisfies the second condition or the terminal device does not fulfill the low mobility criterion, the terminal device may determine the reception state to be the normal reception state.

Optionally, the method illustrated in FIG. 4 may further include step S430.

Step S430, the terminal device may notify the determined reception state to the network device. There is no limitation on the manner in which the terminal device transmits the reception state in the disclosure. For example, the terminal device may transmit the reception state to the network device via RRC signaling or MAC CE signaling.

It can be understood that, if the reception state of the terminal device remains unchanged, the terminal device does not have to notify the determined reception state to the network device, thereby reducing communication messages between the terminal device and the network device.

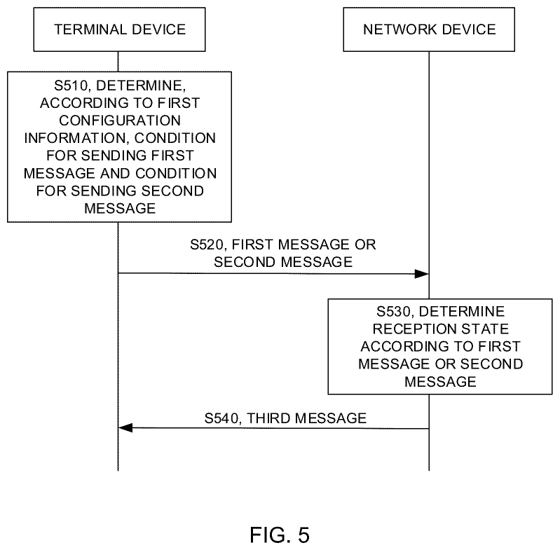

FIG. 5 is a schematic flowchart of a method for determining the reception state of the terminal device by the network device provided in embodiments of the disclosure. The method illustrated in FIG. 5 may be performed by the terminal device and the network device. The method illustrated in FIG. 5 may include step S510 to step S530.

Step S510, the terminal device determines, according to the first configuration information, a condition for sending a first message and a condition for sending a second message.

The network device may determine information of the terminal device according to the first message or the second message, where the first message or the second message may contain the information of the terminal device, for example, information such as a measurement result of the terminal device.

The terminal device may send the first message or the second message under a specific condition. On one hand, the terminal device may determine whether to send the first message or to send the second message, thereby reducing communication burden between the terminal device and the network device. On the other hand, the network device determines the reception state of the terminal device only after the first message or the second message is received, which is possible to reduce the message quantity of the first message or the second message, thereby reducing calculation load of the network device.

It may be understood that, the first message and the second message may be the same message or different messages, and the disclosure is not limited in this regard.

The condition for sending the first message may be different from the condition for sending the second message. For example, if the terminal device determines that the terminal device can enter the LP-WUS reception state from the normal reception state, the terminal device may send the first message to the network device. Alternatively, if the terminal device determines that the terminal device can enter the normal reception state from the LP-WUS reception state, the terminal device may send the second message to the network device.

It can be understood that, any of the first condition, the second condition, and the low mobility criterion may be taken as the condition for sending the first message or the condition for sending the second message. For example, step S510 may include step S511: the terminal device determines the first condition and the second condition according to the first configuration information. Alternatively, step S510 may include step S512: the terminal device determines the first condition, the second condition, and the low mobility criterion according to the first configuration information.

Step S520, the terminal device sends the first message or the second message to the network device.

It can be understood that, the terminal device may determine, according to different conditions, whether to send the first message or to send the second message to the network device.

Exemplarily, step S510 includes step S511. Step S520 may include step S521 or step S522. Step S521, when the terminal device is in the normal reception state, the terminal device may send the first message to the network device if a channel quality measurement result of the serving cell for the terminal device satisfies the first condition. Step S522, when the terminal device is in the LP-WUS reception state, the terminal device may send the second message to the network device if the channel quality measurement result of the serving cell for the terminal device satisfies the second condition.

Exemplarily, step S510 includes step S512. Step S520 may include step S523 or step S524. Step S523, when the terminal device is in the normal reception state, the terminal device may send the first message to the network device if a channel quality measurement result of the serving cell for the terminal device satisfies the first condition and the terminal device fulfills the low mobility criterion. Step S524, when the terminal device is in the LP-WUS reception state, the terminal device may send the second message to the network device if the channel quality measurement result of the serving cell for the terminal device satisfies the second condition or the terminal device does not fulfill the low mobility criterion.

Step 530, the network device determines the reception state of the terminal device according to the first message or the second message.

Step S540, the network device sends a third message to the terminal device, where the third message may contain the reception state of the terminal device.

There is no limitation on the form of the third message in the disclosure. As an embodiment, the third message may be terminal device-specific signaling. For example, the third message may be RRC signaling or MAC CE signaling.

As can be seen, the first condition and the second condition may be used for determining the reception state of the terminal device. A scheme for determining the first condition and the second condition will be described in detail below.

As an embodiment, the first configuration information may include at least one first threshold, and the first condition and the second condition may be determined based on the first threshold.

The first threshold may be configured by the network device. There is no limitation on the manner for configuring the first threshold by the network device in the disclosure. For example, the network device may determine a value of the first threshold based on a coverage range supported by an LP-WUS.

As an embodiment, the first condition includes: the signal quality measurement result of the serving cell for the terminal device is greater than or equal to the at least one first threshold. The second condition includes: the signal quality measurement result of the serving cell for the terminal device is less than or equal to any one of the at least one first threshold.

The at least one first threshold may include one or more measurement thresholds. The measurement threshold may include, for example, at least one of a reference signal received power (RSRP) threshold, a reference signal received quality (RSRQ) threshold, or a signal-to-interference-and-noise ratio (SINR) threshold.

Optionally, when the first configuration information includes multiple first thresholds, if the signal quality measurement result of the serving cell for the terminal device is greater than all of the multiple first thresholds, the first condition is satisfied; otherwise, the second condition is satisfied. For example, the multiple first thresholds include a first RSRP threshold, a first RSRQ threshold, and a first SINR threshold. If an RSRP measurement result of the serving cell for the terminal device is greater than or equal to the first RSRP threshold, an RSRQ measurement result of the serving cell for the terminal device is greater than or equal to the first RSRQ threshold, and an SINR measurement result of the serving cell for the terminal device is greater than or equal to the first SINR threshold, the first condition is satisfied; otherwise, the second condition is satisfied.

As another embodiment, the first configuration information may include at least one second threshold and at least one hysteresis, where the at least one hysteresis is in one-to-one correspondence with the at least one second threshold. The terminal device may determine at least one third threshold and at least one fourth threshold according to the at least one second threshold and the at least one hysteresis.

There is no limitation on the manner for determining the third threshold and the fourth threshold in the disclosure. As an embodiment, the third threshold=the second threshold+the hysteresis, and the fourth threshold=the second threshold−the hysteresis.

The first condition and the second condition may be determined according to the third threshold or the fourth threshold. For example, the first condition may include: the signal quality measurement result of the serving cell for the terminal device is greater than or equal to the at least one third threshold. The second condition may include: the signal quality measurement result of the serving cell for the terminal device is less than or equal to the at least one fourth threshold.

Similar to the first threshold, the at least one second threshold may include one or more measurement thresholds. Optionally, if the first configuration information includes multiple second thresholds, the terminal device may calculate multiple third thresholds and multiple fourth thresholds according to hystereses that are in one-to-one correspondence with the multiple second thresholds. If the signal quality measurement result of the serving cell for the terminal device is greater than or equal to all of the multiple third thresholds, the terminal device may determine that the first condition is satisfied. If the signal quality measurement result of the serving cell for the terminal device is less than or equal to all of the multiple fourth thresholds, the terminal device may determine that the second condition is satisfied. For example, the multiple second thresholds may include a second RSRP threshold, a second RSRQ threshold, and a second SINR threshold. The terminal device may determine, according to a value of each hysteresis, a third RSRP threshold, a third RSRQ threshold, a third SINR threshold, a fourth RSRP threshold, a fourth RSRQ threshold, and a fourth SINR threshold corresponding to the multiple second thresholds. If an RSRP measurement result of the serving cell for the terminal device is greater than or equal to the third RSRP threshold, an RSRQ measurement result of the serving cell for the terminal device is greater than or equal to the third RSRQ threshold, and an SINR measurement result of the serving cell for the terminal device is greater than or equal to the third SINR threshold, the first condition is satisfied. If the RSRP measurement result of the serving cell for terminal device is less than or equal to the fourth RSRP threshold, the RSRQ measurement result of the serving cell for the terminal device is less than or equal to the fourth RSRQ threshold, and the SINR measurement result of the serving cell for the terminal device is less than or equal to the fourth SINR threshold, the second condition is satisfied.

As another embodiment, the first configuration information may include at least one fifth threshold and at least one sixth threshold. The first condition may include: the signal quality measurement result of the serving cell for the terminal device is greater than or equal to the at least one fifth threshold. The second condition may include: the signal quality measurement result of the serving cell for the terminal device is less than or equal to the at least one sixth threshold.

Similar to the first threshold or the second threshold, the at least one fifth threshold may include one or more measurement thresholds, and the at least one sixth threshold may include one or more measurement thresholds. Optionally, if the signal quality measurement result of the serving cell for the terminal device is greater than or equal to all of multiple fifth thresholds, the terminal device may determine that the first condition is satisfied. If the signal quality measurement result of the serving cell for the terminal device is less than or equal to all of multiple sixth thresholds, the terminal device may determine that the second condition is satisfied. For example, the multiple fifth thresholds include a fifth RSRP threshold, a fifth RSRQ threshold, and a fifth SINR threshold; and the multiple sixth thresholds include a sixth RSRP threshold, a sixth RSRQ threshold, and a sixth SINR threshold. If an RSRP measurement result of the serving cell for the terminal device is greater than or equal to the fifth RSRP threshold, an RSRQ measurement result of the serving cell for the terminal device is greater than or equal to the fifth RSRQ threshold, and an SINR measurement result of the serving cell for the terminal device is greater than or equal to the fifth SINR threshold, the first condition is satisfied. If the RSRP measurement result of the serving cell for the terminal device is less than or equal to the sixth RSRP threshold, the RSRQ measurement result of the serving cell for the terminal device is less than or equal to the sixth RSRQ threshold, and the SINR measurement result of the serving cell for the terminal device is less than or equal to the sixth SINR threshold, the second condition is satisfied.

It can be understood that, by setting different threshold values (for example, the third threshold and the fourth threshold, or the fifth threshold and the sixth threshold) for the first condition and the second condition respectively, it is possible to avoid frequent ping-pong transitions of the reception state of the terminal device due to slight fluctuation of the signal quality measurement result.

It should be noted that, for an RRC state that the terminal device is in when performing the foregoing method in the disclosure, for example, the terminal device and the network device can perform the method provided in the disclosure no matter whether the terminal device is in an RRC_IDLE state, in an RRC_CONNECTED state, or in an RRC_INACTIVE state.

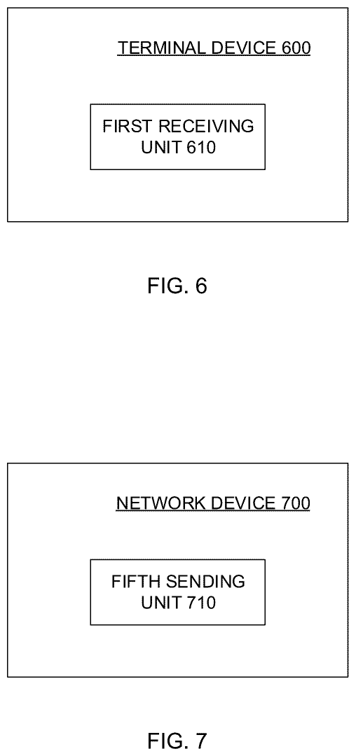

The method embodiments of the disclosure are described in detail above with reference to FIG. 1 to FIG. 5, and the apparatus embodiments of the disclosure will be described in detail below with reference to FIG. 6 to FIG. 8. It should be understood that, elaborations of the method embodiments correspond to elaborations of the apparatus embodiments. Therefore, for the part not described in detail, reference can be made to the foregoing method embodiments.

FIG. 6 is a schematic structural diagram of a terminal device 600 provided in embodiments of the disclosure. The terminal device 600 may include a first receiving unit 610. The first receiving unit 610 may be configured to receive first configuration information sent by a network device, where the first configuration information is used for determining a reception state of the terminal device, and the reception state includes an LP-WUS reception state or a normal reception state.

Optionally, the terminal device 600 may further include a first determining unit, and a second determining unit or a third determining unit. The first determining unit is configured to determine a first condition and a second condition according to the first configuration information. The second determining unit is configured for the terminal device to determine the reception state to be the LP-WUS reception state, if a channel quality measurement result of a serving cell for the terminal device satisfies the first condition. The third determining unit is configured for the terminal device to determine the reception state to be normal reception state, if the channel quality measurement result of the serving cell for the terminal device satisfies the second condition.

Optionally, the terminal device 600 may further include a fourth determining unit, a first sending unit or a second sending unit, and a second receiving unit. The fourth determining unit is configured to determine a first condition and a second condition according to the first configuration information. The first sending unit is configured to send a first message to the network device, if the terminal device is in the normal reception state and a channel quality measurement result of a serving cell for the terminal device satisfies the first condition. The second sending unit is configured to send a second message to the network device, if the terminal device is in the LP-WUS reception state and the channel quality measurement result of the serving cell for the terminal device satisfies the second condition. The second receiving unit is configured to receive a third message, where the third message contains the reception state, and the reception state is determined by the network device according to the first message or the second message.

Optionally, the terminal device 600 may further include a fifth determining unit, and a sixth determining unit or a seventh determining unit. The fifth determining unit is configured to determine a first condition, a second condition, and a low mobility criterion according to the first configuration information. The sixth determining unit is configured to determine the reception state to be the LP-WUS reception state, if a channel quality measurement result of a serving cell for the terminal device satisfies the first condition and the terminal device fulfills the low mobility criterion. The seventh determining unit is configured to determine the reception state to be the normal reception state, if the channel quality measurement result of the serving cell for the terminal device satisfies the second condition or the terminal device does not fulfill the low mobility criterion.

Optionally, the terminal device 600 may further include an eighth determining unit, a third sending unit or a fourth sending unit, and a third receiving unit. The eighth determining unit is configured to determine a first condition, a second condition, and a low mobility criterion according to the first configuration information. The third sending unit is configured to send a first message to the network device, if the terminal device is in the normal reception state, and a channel quality measurement result of a serving cell for the terminal device satisfies the first condition and the terminal device fulfills the low mobility criterion. The fourth sending unit is configured to send a second message to the network device, if the terminal device is in the LP-WUS reception state, and the channel quality measurement result of the serving cell for the terminal device satisfies the second condition or the terminal device does not fulfill the low mobility criterion. The third receiving unit is configured to receive a third message, where the third message contains the reception state, and the reception state is determined by the network device according to the first message or the second message.

Optionally, the first configuration information includes a channel quality change threshold and an evaluation duration, and the low mobility criterion includes: within the evaluation duration, a change amount of a signal quality measurement result of the serving cell for the terminal device is less than or equal to the channel quality change threshold.

Optionally, the first configuration information includes at least one first threshold, where the first condition includes: the signal quality measurement result of the serving cell for the terminal device is greater than or equal to the at least one first threshold, and the second condition includes: the signal quality measurement result of the serving cell for the terminal device is less than or equal to any one of the at least one first threshold.

Optionally, the at least one first threshold includes at least one of: an RSRP threshold, an RSRQ threshold, or an SINR threshold.

Optionally, the first configuration information includes at least one second threshold and at least one hysteresis, where the at least one hysteresis is in one-to-one correspondence with the at least one second threshold. The terminal device 600 may further include a ninth determining unit. The ninth determining unit is configured to determine at least one third threshold and at least one fourth threshold according to the at least one second threshold and the at least one hysteresis, where the first condition includes: the signal quality measurement result of the serving cell for the terminal device is greater than or equal to the at least one third threshold, and the second condition includes: the signal quality measurement result of the serving cell for the terminal device is less than or equal to the at least one fourth threshold.

Optionally, the at least one second threshold includes at least one of: an RSRP threshold, an RSRQ threshold, or an SINR threshold.

Optionally, the first configuration information includes at least one fifth threshold and at least one sixth threshold, where the first condition includes: the signal quality measurement result of the serving cell for the terminal device is greater than or equal to the at least one fifth threshold; and the second condition includes: the signal quality measurement result of the serving cell for the terminal device is less than or equal to the at least one sixth threshold.

Optionally, the at least one fifth threshold or the at least one sixth threshold includes at least one of: an RSRP threshold, an RSRQ threshold, or an SINR threshold.

Optionally, the first configuration information is transmitted via a broadcast message, RRC signaling, or MAC CE signaling.

FIG. 7 is a schematic structural diagram of a network device 700 provided in embodiments of the disclosure. The network device 700 may include a fifth sending unit 710. The fifth sending unit 710 may be configured to send first configuration information to a terminal device, where the first configuration information is used for determining a reception state of the terminal device, and the reception state includes an LP-WUS reception state or a normal reception state.

Optionally, the first configuration information is used for determining a first condition and a second condition. The network device 700 may further include a fourth receiving unit or a fifth receiving unit, and a sixth sending unit. The fourth receiving unit is configured to receive a first message sent by the terminal device, if the terminal device is in the normal reception state and a channel quality measurement result of a serving cell for the terminal device satisfies the first condition. The fifth receiving unit is configured to receive a second message sent by the terminal device, if the terminal device is in the LP-WUS reception state and the channel quality measurement result of the serving cell for the terminal device satisfies the second condition. The sixth sending unit is configured to send a third message, where the third message contains the reception state, and the reception state is determined by the network device according to the first message or the second message.

Optionally, the first configuration information is used for determining a first condition, a second condition, and a low mobility criterion. The network device 700 may further include a sixth receiving unit or a seventh receiving unit, and a seventh sending unit. The sixth receiving unit is configured to receive a first message sent by the terminal device, if the terminal device is in the normal reception state, and a channel quality measurement result of a serving cell for the terminal device satisfies the first condition and the terminal device fulfills the low mobility criterion. The seventh receiving unit is configured for the network device to receive a second message sent by the terminal device, if the terminal device is in the LP-WUS reception state, and the channel quality measurement result of the serving cell for the terminal device satisfies the second condition or the terminal device does not fulfill the low mobility criterion. The seventh sending unit is configured to send a third message, where the third message contains the reception state, and the reception state is determined by the network device according to the first message or the second message.

Optionally, the first configuration information includes a channel quality change threshold and an evaluation duration, and the low mobility criterion includes: within the evaluation duration, a change amount of a signal quality measurement result of the serving cell for the terminal device is less than or equal to the channel quality change threshold.

Optionally, the first configuration information includes at least one first threshold, where the first condition includes: the signal quality measurement result of the serving cell for the terminal device is greater than or equal to the at least one first threshold, and the second condition includes: the signal quality measurement result of the serving cell for the terminal device is less than or equal to any one of the at least one first threshold.

Optionally, the at least one first threshold includes at least one of: an RSRP threshold, an RSRQ threshold, or an SINR threshold.

Optionally, the first configuration information includes at least one second threshold and at least one hysteresis, where the at least one hysteresis is in one-to-one correspondence with the at least one second threshold, and the at least one second threshold and the at least one hysteresis are used for determining at least one third threshold and at least one fourth threshold. The first condition includes: the signal quality measurement result of the serving cell for the terminal device is greater than or equal to the at least one third threshold. The second condition includes: the signal quality measurement result of the serving cell for the terminal device is less than or equal to the at least one fourth threshold.

Optionally, the at least one second threshold includes at least one of: an RSRP threshold, an RSRQ threshold, or an SINR threshold.

Optionally, the first configuration information includes at least one fifth threshold and at least one sixth threshold. The first condition includes: the signal quality measurement result of the serving cell for the terminal device is greater than or equal to the at least one fifth threshold. The second condition includes: the signal quality measurement result of the serving cell for the terminal device is less than or equal to the at least one sixth threshold.

Optionally, the at least one fifth threshold or the at least one sixth threshold includes at least one of: an RSRP threshold, an RSRQ threshold, or an SINR threshold.

Optionally, the first configuration information is transmitted via a broadcast message, RRC signaling, or MAC CE signaling.

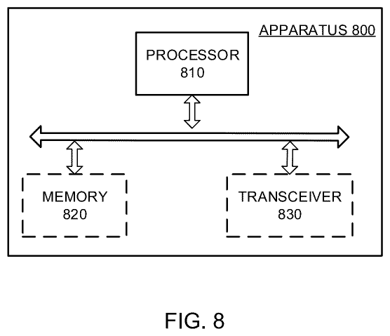

FIG. 8 is a schematic structural diagram of a communication apparatus according to embodiments of the disclosure. A dashed line in FIG. 8 indicates that the unit or module is optional. The apparatus 800 may be a chip, a terminal device, or a network device.

The apparatus 800 may include one or more processors 810. The processor 810 may support the apparatus 800 to implement the method described in the foregoing method embodiments. The processor 810 may be a general-purpose processor or a special-purpose processor. For example, the processor may be a central processing unit (CPU). Alternatively, the processor may also be other general-purpose processors, a digital signal processor (DSP), an application specific integrated circuit (ASIC), a field programmable gate array (FPGA), or other programmable logic devices, discrete gates or transistor logic devices, or discrete hardware components. The general-purpose processor may be a microprocessor, or the processor may also be any conventional processor.

The apparatus 800 may further include one or more memories 820. The memory 820 is configured to store programs. The programs may be executed by the processor 810, so that the processor 810 performs the method described in the foregoing method embodiments. The memory 820 may be independent from the processor 810, or may be integrated into the processor 810.

The apparatus 800 may further include a transceiver 830. The processor 810 may communicate with other devices or chips via the transceiver 830. For example, the processor 810 may perform data transmission and reception with other devices or chips via the transceiver 830.

Embodiments of the disclosure further provide a computer-readable storage medium. The computer-readable storage medium is configured to store programs. The computer-readable storage medium may be applied to the terminal or the network device provided in embodiments of the disclosure, and the programs are operable with a computer to perform the method implemented by the terminal or the network device in various embodiments of the disclosure.

Embodiments of the disclosure further provide a computer program product. The computer program product includes programs. The computer program product may be applied to the terminal or the network device provided in embodiments of the disclosure, and the programs are operable with a computer to perform the method implemented by the terminal or the network device in various embodiments of the disclosure.

Embodiments of the disclosure further provide a computer program. The computer program may be applied to the terminal or the network device provided in embodiments of the disclosure, and the computer program is operable with a computer to perform the method implemented by the terminal or the network device in various embodiments of the disclosure.

It should be understood that, the terms “system” and “network” herein are usually used interchangeably throughout this disclosure. In addition, the terms used in the disclosure are only intended for explaining embodiments of the disclosure, rather than limiting the disclosure. The terms “first”, “second”, “third”, and “fourth”, etc. in the specification and claims of the disclosure and the accompanying drawings are used for distinguishing different objects, and are not necessarily used for describing a particular order. Furthermore, the terms “include”, “comprise”, and “have” as well as variations thereof are intended to cover non-exclusive inclusion.

“Indication” referred to in embodiments of the disclosure may be a direct indication, may be an indirect indication, or may mean that there is an association. For example, A indicates B may mean that A directly indicates B, for instance, B can be obtained according to A; may mean that A indirectly indicates B, for instance, A indicates C, and B can be obtained according to C; or may mean that that there is an association between A and B.

In embodiment of the disclosure, “B corresponding to A” means that B is associated with A, and B can be determined according to A. However, “B can be determined according to A” does not mean that B can be determined only according to A, and instead, B can be determined according to A and/or other information.

In embodiments of the disclosure, the term “correspondence” may mean that there is a direct or indirect correspondence between the two, may mean that there is an association between the two, or may mean a relationship of indicating and indicated or configuring and configured, etc.

In the embodiments of the disclosure, the “pre-defined” or “pre-configured” can be implemented by pre-storing a corresponding code or table in a device (for example, including the terminal device and the network device) or in other manners that can be used for indicating related information, and the disclosure is not limited in this regard. For example, the “pre-defined” may mean defined in a protocol.

In embodiments of the disclosure, the “protocol” may refer to a communication standard protocol, which may include, for example, an LTE protocol, an NR protocol, and a protocol applied to a future communication system, and the disclosure is not limited in this regard.

The term “and/or” herein only describes an association between associated objects, which means that there can be three relationships. For example, A and/or B can mean A alone, both A and B exist, and Balone. In addition, the character “/” herein generally indicates that the associated objects are in an “or” relationship.

In various embodiments of the disclosure, the magnitude of a sequence number of each process does not mean an order of execution, and the order of execution of each process should be determined by its function and an internal logic and shall not constitute any limitation to the implementation of embodiments of the disclosure.

It will be appreciated that the systems, apparatuses, and methods disclosed in embodiments of the disclosure may also be implemented in various other manners. For example, the above apparatus embodiments are merely illustrative, e.g., the division of units is only a division of logical functions, and other manners of division may be available in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device, or unit, and may be electrical, mechanical, or otherwise.

Separated units as illustrated may or may not be physically separated. Components displayed as units may or may not be physical units, and may reside at one location or may be distributed to multiple networked units. Some or all of the units may be selectively adopted according to practical needs to achieve desired objectives of the disclosure.

In addition, various functional units described in various embodiments of the disclosure may be integrated into one processing unit or may be present as a number of physically separated units, and two or more units may be integrated into one.

All or some of the foregoing embodiments can be implemented by software, hardware, firmware, or any other combination thereof. When implemented by software, all or some the foregoing embodiments can be implemented in the form of a computer program product. The computer program product includes one or more computer instructions. When the computer instructions are applied and executed on a computer, all or some the operations or functions of the embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer accessible usable-medium or a data storage device such as a server, a data center, or the like which integrates one or more usable media. The usable medium can be a magnetic medium (such as a soft disk, a hard disk, or a magnetic tape), an optical medium (such as a digital video disc (DVD)), or a semiconductor medium (such as a solid state disk (SSD)), etc.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

I/We claim:

1. A communication method, comprising:
receiving, by a terminal device, first configuration information sent by a network device, wherein the first configuration information is used for determining a reception state of the terminal device, and the reception state comprises a low-power wake-up signal (LP-WUS) reception state or a normal reception state.

2. The method of claim 1, further comprising:
determining, by the terminal device, a first condition and a second condition according to the first configuration information; and
determining, by the terminal device, the reception state to be the LP-WUS reception state, when a channel quality measurement result of a serving cell for the terminal device satisfies the first condition; or determining, by the terminal device, the reception state to be the normal reception state, when the channel quality measurement result of the serving cell for the terminal device satisfies the second condition.

3. The method of claim 1, further comprising:
determining, by the terminal device, a first condition and a second condition according to the first configuration information;
sending, by the terminal device, a first message to the network device, when the terminal device is in the normal reception state and a channel quality measurement result of a serving cell for the terminal device satisfies the first condition; or sending, by the terminal device, a second message to the network device, when the terminal device is in the LP-WUS reception state and the channel quality measurement result of the serving cell for the terminal device satisfies the second condition; and
receiving, by the terminal device, a third message, wherein the third message contains the reception state, and the reception state is determined by the network device according to the first message or the second message.

4. The method of claim 1, further comprising:
determining, by the terminal device, a first condition, a second condition, and a low mobility criterion according to the first configuration information; and
determining, by the terminal device, the reception state to be the LP-WUS reception state, when a channel quality measurement result of a serving cell for the terminal device satisfies the first condition and the terminal device fulfills the low mobility criterion; or determining, by the terminal device, the reception state to be the normal reception state, when the channel quality measurement result of the serving cell for the terminal device satisfies the second condition or the terminal device does not fulfill the low mobility criterion.

5. The method of claim 1, further comprising:
determining, by the terminal device, a first condition, a second condition, and a low mobility criterion according to the first configuration information;
sending, by the terminal device, a first message to the network device, when the terminal device is in the normal reception state, and a channel quality measurement result of a serving cell for the terminal device satisfies the first condition and the terminal device fulfills the low mobility criterion; or sending, by the terminal device, a second message to the network device, when the terminal device is in the LP-WUS reception state, and the channel quality measurement result of the serving cell for the terminal device satisfies the second condition or the terminal device does not fulfill the low mobility criterion; and
receiving, by the terminal device, a third message, wherein the third message contains the reception state, and the reception state is determined by the network device according to the first message or the second message.

6. The method of claim 4, wherein the first configuration information comprises a channel quality change threshold and an evaluation duration, and the low mobility criterion comprises: within the evaluation duration, a change amount of a signal quality measurement result of the serving cell for the terminal device is less than or equal to the channel quality change threshold.

7. The method of claim 2, wherein the first configuration information comprises at least one first threshold, wherein the first condition comprises: a signal quality measurement result of the serving cell for the terminal device is greater than or equal to the at least one first threshold, and the second condition comprises: the signal quality measurement result of the serving cell for the terminal device is less than or equal to any one of the at least one first threshold.

8. The method of claim 7, wherein the at least one first threshold comprises at least one of: a reference signal received power (RSRP) threshold, a reference signal received quality (RSRQ) threshold, or a signal-to-interference-and-noise ratio (SINR) threshold.

9. The method of claim 2, wherein the first configuration information comprises at least one second threshold and at least one hysteresis, the at least one hysteresis is in one-to-one correspondence with the at least one second threshold, and the method further comprises:
determining, by the terminal device, at least one third threshold and at least one fourth threshold according to the at least one second threshold and the at least one hysteresis, wherein
the first condition comprises: a signal quality measurement result of the serving cell for the terminal device is greater than or equal to the at least one third threshold, and the second condition comprises: the signal quality measurement result of the serving cell for the terminal device is less than or equal to the at least one fourth threshold.

10. The method of claim 9, wherein the at least one second threshold comprises at least one of: an RSRP threshold, an RSRQ threshold, or an SINR threshold.

11. The method of claim 2, wherein the first configuration information comprises at least one fifth threshold and at least one sixth threshold, wherein the first condition comprises: a signal quality measurement result of the serving cell for the terminal device is greater than or equal to the at least one fifth threshold, and the second condition comprises:
the signal quality measurement result of the serving cell for the terminal device is less than or equal to the at least one sixth threshold.

12. The method of claim 11, wherein the at least one fifth threshold or the at least one sixth threshold comprises at least one of: an RSRP threshold, an RSRQ threshold, or an SINR threshold.

13. The method of claim 1, wherein the first configuration information is transmitted via a broadcast message, radio resource control (RRC) signaling, or media access control-control element (MAC CE) signaling.

14. A network device, comprising:
a transceiver;
a processor; and
a memory storing computer readable programs which, when executed by the processor, configure the processor to:
cause the transceiver to send first configuration information to a terminal device, wherein the first configuration information is used for determining a reception state of the terminal device, and the reception state comprises a low-power wake-up signal (LP-WUS) reception state or a normal reception state.

15. The network device of claim 14, wherein the first configuration information is used for determining a first condition and a second condition, and the processor is further configured to execute the computer readable programs to:
cause the transceiver to receive a first message sent by the terminal device, when the terminal device is in the normal reception state and a channel quality measurement result of a serving cell for the terminal device satisfies the first condition; or receiving, by the network device, a second message sent by the terminal device, when the terminal device is in the LP-WUS reception state and the channel quality measurement result of the serving cell for the terminal device satisfies the second condition; and
cause the transceiver to send a third message, where the third message contains the reception state, and the reception state is determined by the network device according to the first message or the second message.

16. The network device of claim 14, wherein the first configuration information is used for determining a first condition, a second condition, and a low mobility criterion, and the processor is further configured to execute the computer readable programs to:
cause the transceiver to receive a first message sent by the terminal device, when the terminal device is in the normal reception state, and a channel quality measurement result of a serving cell for the terminal device satisfies the first condition and the terminal device fulfills the low mobility criterion; or receiving, by the network device, a second message sent by the terminal device, when the terminal device is in the LP-WUS reception state, and the channel quality measurement result of the serving cell for the terminal device satisfies the second condition or the terminal device does not fulfill the low mobility criterion; and
cause the transceiver to send a third message, wherein the third message contains the reception state, and the reception state is determined by the network device according to the first message or the second message.

17. The network device of claim 16, wherein the first configuration information comprises a channel quality change threshold and an evaluation duration, and the low mobility criterion comprises: within the evaluation duration, a change amount of a signal quality measurement result of the serving cell for the terminal device is less than or equal to the channel quality change threshold.

18. The network device of claim 15, wherein the first configuration information comprises at least one first threshold, wherein the first condition comprises: a signal quality measurement result of the serving cell for the terminal device is greater than or equal to the at least one first threshold, and the second condition comprises: the signal quality measurement result of the serving cell for the terminal device is less than or equal to any one of the at least one first threshold.

19. A terminal device, comprising:
a transceiver;
a processor; and
a memory storing computer readable programs which, when executed by the processor, configure the processor to:
cause the transceiver to receive first configuration information sent by a network device, wherein the first configuration information is used for determining a reception state of the terminal device, and the reception state comprises a low-power wake-up signal (LP-WUS) reception state or a normal reception state.

20. The terminal device of claim 19, wherein the processor is further configured to execute the computer readable programs to:
determine a first condition and a second condition according to the first configuration information; and
determine the reception state to be the LP-WUS reception state, when a channel quality measurement result of a serving cell for the terminal device satisfies the first condition; or a third determining unit configured for the terminal device to determine the reception state to be the normal reception state, when the channel quality measurement result of the serving cell for the terminal device satisfies the second condition.
